(19) United States
(12) Patent Application Publication
(10) Pub. No.: US 2015/0380698 A1
(43) Pub. Date: Dec. 31, 2015

(54) SYSTEM COMPRISING A BATTERY TRAY AND A TRAY HOLDER FOR MOUNTING THE BATTERY TRAY IN A BATTERY BOX OF A WIND POWER INSTALLATION

(71) Applicant: MOOG UNNA GMBH, Unna (DE)

(72) Inventors: Michael Springauf, Lichtenau (DE); Bernd Franzak, Lunen (DE)

(21) Appl. No.: 14/438,408

(22) PCT Filed: Oct. 23, 2013
(86) PCT No.: PCT/EP2013/072158

§ 371 Date: Aug. 7, 2015

(30) Foreign Application Priority Data
Oct. 26, 2012 (EP) 12190153.2

(51) Int. Cl. H01M 2/10

(52) U.S. Cl. CPC H01M 2/1077; H01M 2220/10

(57) ABSTRACT

The invention relates to a system comprising at least one battery tray and a tray holder, in particular for mounting the at least one battery tray in a battery box of a wind power installation, wherein the tray holder has a bearing side by means of which the battery tray can be placed on the tray holder, characterized in that the tray holder has an interlocking receptacle, wherein the battery tray is placed on the bearing side in a mounting position when it is held in an interlocking manner in the interlocking holder by means of a first side, wherein the tray holder has, at a distance from the interlocking holder, a fastening means for a force-fitting connection of a second side of the battery tray, and wherein the second side of the battery tray is pre-aligned in relation to the fastening means when the battery tray is in the mounting position.

The invention relates to a system comprised of at least one tray holder, in particular for mounting the at least one battery tray in a battery box of a wind power plant, the tray holder having a bearing side by means of which the battery tray can be placed on the tray holder.

It is essential for the operational safety of wind power plants that the pitch system of the wind powerinstallation can continue to be operated even in the event of a power outage in order to turn the blades of the wind power plant out of the wind, for example, when a storm is approaching. 15 To make this possible, generic wind power plants have a separate battery box for each blade with one or more batteries contained therein. The battery boxes are each assigned to a specific blade and are arranged on the hub of the wind power plant in such a way that they rotate along with the wind power plant while it is in operation.

The batteries must be regularly replaced according to prescribed service intervals. To make it possible to replace the batteries, they are held in battery trays, which are typically connected to the battery box via Halfen channels in the interior of the battery box. The battery trays are screwed to the Halfen channels using stainless steel screws. In the event of service, the battery trays must first be brought into a non-slip, secure position. To do this, it is necessary for the wind power plant to be horizontally aligned with respect to each individual battery box and bolted down, this operation already having to be performed for every blade separately, thus being time-consuming. After the alignment of the wind power plant, the service personnel can enter the hub of the wind power plant, it being necessary for alignment of the next blade to again leave the hub of the wind power plant along with the enormous tool. In principal, with wind power plants it is necessary to keep the down times of the plant to a minimum in order to achieve high efficiencies.

Furthermore, the stainless steel screws used for screwing the battery trays into the battery boxes have a high degree of wear because of the high tightening torque values, so that these too must be regularly checked and replaced when necessary. The entire service operation for replacing the batteries in the known systems is therefore very time-consuming and laborious.

It is therefore the object of the invention to provide a generic system comprising at least one battery tray and at least one tray holder that enables a replacement of the battery tray that is as simple as possible.

This objective is achieved according to the invention through a system having the features of claim 1. The dependent claims 2 to 12 each relate to advantageous embodiments of the invention.

The system according to the invention is characterized in that the tray holder has an interlocking receptacle, the battery tray being placed on the bearing side in the mounting position when it is held in an interlocking manner in the interlocking receptacle by means of a first side, the tray holder having, at a distance from the interlocking receptacle, a fastening means for a friction-locked connection of a second side of the battery tray, and the second side of the battery tray being pre-aligned with respect to the fastening means when the battery tray is in the installed position.

In the system according to the invention, the battery tray is thus pre-positioned by being inserted in the interlocking receptacle far enough and brought into an installed position such that a friction-locked connection or an additional interlocking connection between battery tray and tray holder can be produced in a simple way via the fastening means. The interlocking receptacle is preferably configured in such a way that when a battery tray is inserted just one movement of the battery tray is allowed in a slide-in direction along which the battery tray can be inserted into the interlocking receptacle and removed again and the battery is otherwise fixed in the remaining spatial directions. With the aid of the fastening means, the battery tray in the installed position can then be also fixed in the slide-in direction via the second side, and thus held in a fixed position overall.

Thus, according to one embodiment, it is conceivable, for example, that the fastener has a cut-out in a flange of the battery tray which in the installed position is aligned with a corresponding cut-out in the tray holder so that an interlocking or friction-locked connection between the tray holder and the battery tray can be produced by simply inserting a self-securing locking fixture in the aligned cut-outs. 10 The previously described measures, namely the insertion of the battery tray in the interlocking receptacle so that it is brought into the installed position and the subsequent fixing of the battery tray on the tray holder using the fastening means can be performed by service personnel even under constricted conditions in the wind power plant, for example, even overhead. As a result, it is no longer necessary to re-align the blades of the wind power plant between the installation of two battery trays.

In one embodiment of the invention, the interlocking receptacle has a clip with an undercut that is detachable or permanently connected to the tray holder, the undercut being disposed at a distance from the bearing side so that an open space for the interlocking accommodation of the battery tray, in particular of a flange that delimits it, is formed between the undercut and the bearing side, and the open space being open in the direction of the fastening means. The clip can be designed as a component that is detachably insertable in the tray holder so that it can easily be replaced if necessary without great effort.

Preferably, the undercut has a pre-tensioning in the direction of the bearing side. In this way, the battery tray is already fixed in the interlocking receptacle in such a way that the battery tray is securely held in the installation position at least until the fastening means is actuated.

In order to enable as simple a release of the battery tray from the tray holder as possible for the replacement of the batteries, in one embodiment of the invention, it is provided that the clip is formed by an elastic clasp, an actuating lever being integrally formed on the undercut so that the undercut is adjustable against the pre-tensioning.

In order to ensure that the battery tray is guided exactly into the installation position when inserted into the interlocking receptacle and to give the service personnel tactile feedback about when the installed position has been reached as the battery tray is inserted in the interlocking receptacle, the clip, in one embodiment of the invention, has a stop that limits an insertion movement of the battery tray. For this purpose, it is especially preferable that the open space is configured for the interlocking accommodation of a flange which delimits the battery tray, the stop being positioned upstream from the open space in the insertion direction, and the flange having a recess extending in the direction of the insertion movement in which the stop is guided.

Preferably, the recess extends here between an outer boundary of the flange and a wall element of the battery tray, the stop being guided within the recess in an interlocking manner so that the battery tray is fixed in the plane of the bearing side that is perpendicular to the direction of insertion.

After the battery tray has been inserted via its first side into the interlocking receptacle and preferably after the battery tray has been connected via its second side and the fastening means to the tray holder, the battery tray can also be connected frictionally locked to the tray holder via the interlocking receptacle. To this end, one embodiment provides that the interlocking receptacle and the battery tray have corresponding fastening means for the friction-locked connection of the battery tray with the tray holder, the corresponding means aligning when the battery tray is in the installed position. Especially preferably, the interlocking receptacle also has a threaded receptacle, such as a weld nut or a threaded pin, a flange of the battery tray by which the battery tray can be held in the interlocking connection having at least one receptacle for a threaded pin. In order to enable unobstructed insertion of the flange into the interlocking receptacle, for example, if a threaded pin is already partially screwed into the threaded receptacle, the at least one feed-through is a slot, which extends in the insertion direction of the battery tray from an outer boundary of the flange.

The tray holder can be formed of one piece or multiple parts. The tray holder can be designed for the installation of a battery tray or for the installation of multiple battery trays. The tray holder can be a mounting rail or a mounting plate that is detachably connected, for example, screwed to the battery box, permanently connected to it or formed as one piece therewith. In one embodiment, the tray holder is formed as one piece and has a first end on which the interlocking receptacle is disposed. It also has, opposite the first end, a second end on which the fastening means is disposed.

In another embodiment, the tray holder has two mounting rails, one of the mounting rails having the interlocking receptacle and a first section of the bearing side and the other of the mounting rails having the fastening means and a second section of the bearing side. In order to enable a manufacture and installation of the tray holders that is as simple as possible, one embodiment provides that the mounting rails are identical parts and in, alternating sequence, have at least one interlocking receptacles and at least one fastening means.

Other details of the invention are explained with reference to the figures below. Shown are:

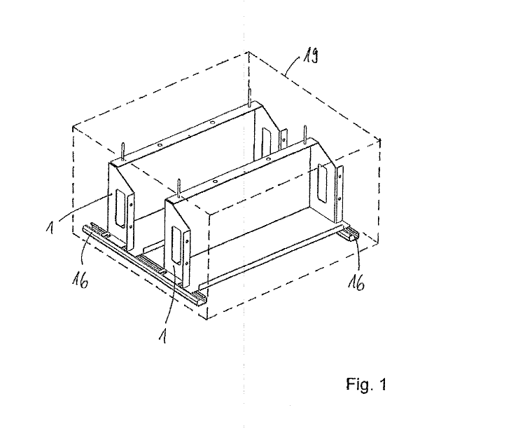

FIG. 1 a perspective cross-sectional view of a battery box according to the prior art;

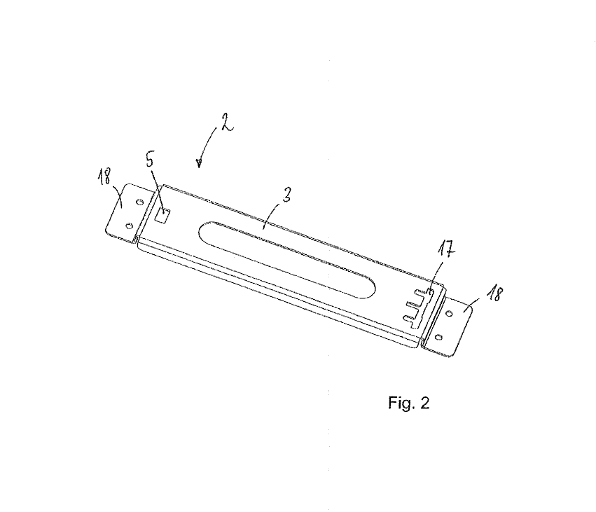

FIG. 2 a perspective view of a tray holder according to one embodiment of the invention;

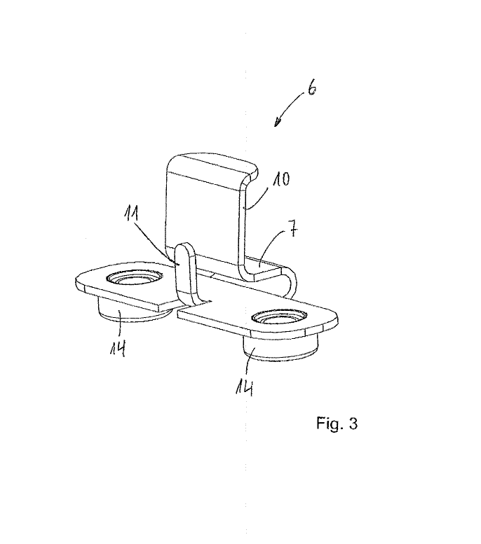

FIG. 3 a perspective view of an interlocking receptacle according to one embodiment of the invention;

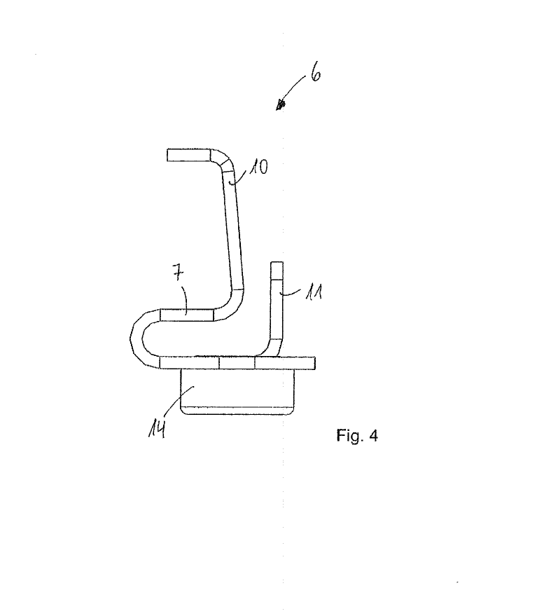

FIG. 4 a cross-sectional view of the interlocking receptacle according to FIG. 3;

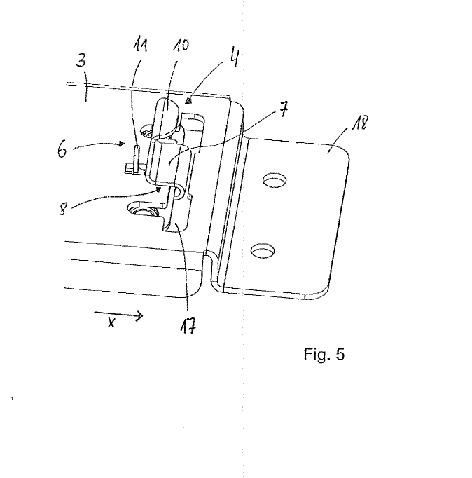

FIG. 5 a detail view of the tray holder according to FIG. 2 with an inserted interlocking receptacle according to FIGS. 3 and 4;

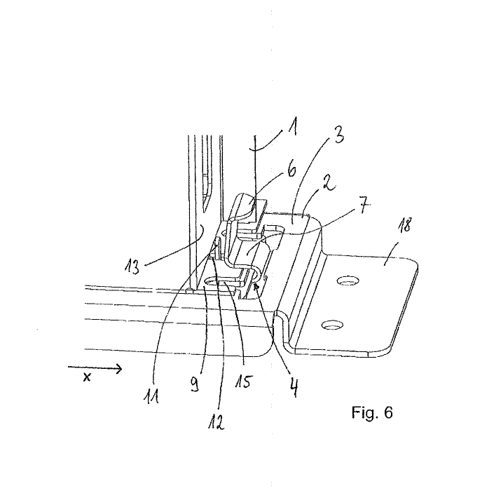

FIG. 6 a detail view according to FIG. 5 with the battery tray partly inserted in the interlocking receptacle; and

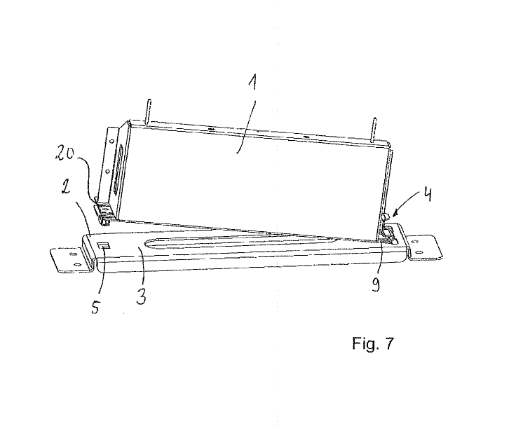

FIG. 7 a visualization of the insertion movement of the battery tray into the interlocking receptacle of the tray holder.

FIG. 1 shows a generic system having two battery trays 1, which are installed via two parallel Halfen channels 16 in a battery box 19. For this purpose, the battery trays 1 are screwed to Halfen channels 16 using four screws. Because battery trays 1 are not in any way pre-aligned or pre-affixed to Halfen channels 16 prior to being screwed on, the battery box 19 must be brought into a horizontal alignment for the assembly or removal of battery trays 1 so that battery trays 1 stand up securely on Halfen channels 16. Because of the heavy weight of the batteries and because of the constricted space conditions in the hub of the wind power plant, the installation of battery trays 1 in the battery box 19 with the systems known from the prior art is very difficult if the battery box 19 is not pre-aligned as previously described. The result of this is that for each blade of the wind power plant the particular battery box 19 must be separately brought into the horizontal position in order to facilitate the installation or the replacement of the battery trays 1.

The tray holder 2 according to the invention which is shown in FIG. 2 is a multi-compartment, beveled, shaped sheet metal part with mounting flanges 18 for the attachment of the tray holder 2, for example, to the base of a battery box 19 according to FIG. 1. The tray holder 2 has a cut-out 17 that is provided in order to hold a clip 6 according to FIGS. 3 and 4. The cut-out 17 has slot-like recesses, the center recess serving to guide the stop 11 of the clip 6 (see FIG. 3) when the clip 6 is inserted into the cut-out 17. This ensures that the weld nuts 14 of the clip 6 are aligned with the two outer slot-like recesses of the cut-out 17. At its opposite end, the tray holder 2 has fastening means 5 configured in the shape of a rectangular cut-out. The cut-out 5 can serve to accommodate a self-securing locking fixture 20 (see FIG. 7).

FIGS. 3 and 4 illustrate the preferred embodiment of the clip 6. The clip 6 has an undercut 7 from which an actuating lever 10 is bent. The clip 6 also has two weld nuts 14 that are spaced apart from each other, the stop 11 being arranged between the weld nuts 14. The stop 11 extends essentially perpendicular to undercut 7.

FIG. 5 shows a detail view of the tray holder 2 according to FIG. 2 with the clip 6 inserted in the cut-out 17. The undercut 7 of the clip 6 is arranged at a distance from the bearing side 3 of the tray holder 2 so that an open area 8 is formed between the undercut 7 and the bearing side 3. The stop 11 is guided into a slot-like recess of the cut-out 17 of the tray holder 2. It should also be noted that the stop 11 is positioned upstream from the open area 8 in insertion direction x in the interlocking receptacle 4.

FIG. 6 shows the arrangement according to FIG. 5 with the battery tray 1 partially inserted in the open area 8. Only when the wall element 13 of the battery tray 1 is positioned against the stop 11 of clip 6 has the battery tray 1 reached its installed position. The stop 11 is guided within the recess 12 of the flange 9 in an interlocking manner so that as a result the interaction of the stop 11 and recess 12 predetermines a pre-alignment of the battery tray within the plane of the bearing side 3 and perpendicular to the insertion direction x. While the interaction of the stop 11 and recess 12 predetermines the alignment of the battery tray 1 in the plane of the bearing side 3, the flange 9 of the battery tray 1 is precisely fixed in the direction perpendicular to the bearing side 3 by the undercut 7. The flange 9 is therefore held in the interlocking receptacle 4 in an interlocking manner to the extent that, merely by shifting the battery tray to be non-parallel to the insertion direction x, it can be removed again from the interlocking receptacle 4.

As shown in FIGS. 3 and 4, the undercut 7 transitions via a round bend into the actuation lever 10, whereby the engagement of the flange 9 in the open area 8 formed between the undercut 7 and bearing side 3 is facilitated. This is shown in FIG. 7. Before the battery tray 1 is placed on the tray holder 2, a self-securing locking fixture 20 can be inserted into a flange of the battery tray 1 that is positioned opposite the flange 9 so that when the installed position of the battery tray 1 on the bearing side 3 of the tray holder 2 is reached, the locking fixture 20 projects through the fastening means 5, which is configured as a rectangular opening, and automatically fixes the battery tray 1 to the tray holder 2. After the battery holder 1 has been pre-installed on the tray holder as previously described, pins can be screwed into the weld nuts 14 of the clip 6 through the feed-throughs 15 of the battery tray 1 (see FIG. 6) in order to also create a friction-locked connection between the battery tray 1 and the tray holder 2 on the sides of the interlocking receptacle 4.

The features of the invention disclosed in the preceding description, in the drawings and in the claims can be essential for the realization of the invention both individually and in any desired combination.

### LIST OF REFERENCE NUMBERS

1 Battery tray

2 Tray holder

3 Bearing side

4 Interlocking receptacle

5 Fastening means

6 Clip

7 Undercut

8 Clearance

9 Flange

10 Actuation lever

11 Stop

12 Recess

13 Wall element

14 Weld nut

15 Feed-through

16 Halfen channel

17 Cut-out

18 Mounting flange

19 Battery box

20 Self-securing locking fixture

1-12. (canceled)

13. A system comprising:
at least one battery tray;
at least one tray holder for mounting the battery tray in a battery box of a wind power plant, the tray holder comprising:
a bearing side configured and arranged such that the battery tray can be placed on the tray holder in an installed position;
an interlocking receptacle configured and arranged to hold a first side of the battery tray in an interlocking manner when the battery tray is placed on the bearing side of the tray holder in the installed position; and
a fastening element positioned a distance from the interlocking receptacle and being pre-aligned in relation to a second side of the battery tray so as to connect the tray holder to the second side of the battery tray when the battery tray is in the installed position.

14. The system according to claim 13, wherein the first side of the battery tray comprises a flange and the interlocking receptacle comprises a clip having an undercut portion which is detachable or permanently connected to the tray holder, the undercut portion being disposed a distance from the bearing side of the tray holder so as to form an open space between the undercut and the bearing side of the tray holder that is configured and arranged to receive at least a portion of the flange of the battery tray when the battery tray is placed on the bearing side of the tray holder in the installed position, the open space being open in the direction of the fastening element.

15. The system according to claim 14, wherein the undercut portion has a pre-tensioning in the direction of the bearing side of the tray holder.

16. The system according to claim 15, wherein the clip comprises an elastic clasp and an actuation lever integrally formed on the undercut portion such that the undercut portion is adjustable against the pre-tensioning.

17. The system according to claim 14, wherein the clip comprises a stop configured and arranged to limit an insertion movement of the battery tray on the bearing side of the tray holder in an insertion direction opposite the direction of the fastening element.

18. The system according to claim 17, wherein:
the flange comprises an interlocking fixture;
the open space is designed for the interlocking fixture of the flange that delimits the battery tray;
the stop is positioned upstream from the open space in the insertion direction; and
the flange has a recess configured and arranged to receive the stop.

19. The system according to claim 18, wherein the recess comprises a slot extending from an outer boundary of the flange in the direction of the fastening element to a wall element of the battery tray and the stop is guided within the slot in an interlocking manner such that the battery tray is fixed in the plane of the bearing side perpendicular to the insertion direction.

20. The system according to claim 13, wherein the interlocking receptacle and the battery tray have corresponding fastening elements which are aligned when the battery tray is in the installed position and which are configured and arranged to provide a friction-locked connection of the battery tray with the tray holder when the battery tray is in the installed position.

21. The system according to claim 13, wherein the interlocking receptacle comprises at least one threaded receptacle, the battery tray comprises a flange having at least one feed-through for a threaded pin, and the at least one feed-through comprises a slot extending from an outer boundary of the flange in the direction of the fastening element.

22. The system according to claim 21, wherein the threaded receptacle comprises a welded nut or a threaded pin.

23. The system according to claim 13, wherein the tray holder is designed as one piece and comprises a first end on which the interlocking receptacle is arranged and a second end situated opposite the first end on which the fastening element is arranged.

24. The system according to claim 13, wherein the tray holder comprises two mounting rails, one of the mounting rails having the interlocking receptacle and a first section of the bearing side and the other of the mounting rails having the fastening element and a second section of the bearing side.

25. The system according to claim 24, wherein the mounting rails are identical parts and in alternating sequence have at least one interlocking receptacle and at least one fastening element.
